(19) United States
(12) Patent Application Publication
(10) Pub. No.: US 2020/0088513 A1
(43) Pub. Date: Mar. 19, 2020

(54) THREE DIMENSIONAL SCAN SYSTEM WITH INCREASED RANGE OF RESOLUTION

(71) Applicant: QISDA CORPORATION, Taoyuan City (TW)

(72) Inventors: Chih-Chieh Tsung, Taoyuan City (TW); Tsung-Hsun Wu, Taoyuan City (TW); Ming-Kuen Lin, Taoyuan City (TW)

(21) Appl. No.: 16/554,629

(22) Filed: Aug. 29, 2019

(30) Foreign Application Priority Data
Sep. 19, 2018 (CN) 201811094848.X

(51) Int. Cl. G01B 11/25; G02B 27/10; H04N 5/225

(52) U.S. Cl. CPC G01B 11/2518; H04N 5/2256; G02B 27/1006

(57) ABSTRACT

A three-dimensional scan system includes a projection module including a light source for providing a first light beam and a second light beam and a pattern generator for receiving the first light beam to project a first pattern and for receiving the second light beam to project a second pattern, an image capturing module for capturing an image of the first pattern and the second pattern projected on an object, and a beam splitting module including a first reflective surface for reflecting the first light beam to project the first pattern onto the object and reflecting the first light beam reflected by the object to the image capturing module and a second reflective surface for reflecting the second light beam to project the second pattern onto the object and reflecting the second light beam reflected by the object to the image capturing module.

### BACKGROUND OF THE INVENTION

### 1. Field of the Invention

The present invention is related to a three-dimensional scan system, and more particularly to a three-dimensional scan system capable of increasing the range of effective resolution.

### 2. Description of the Prior Art

A scan device can be used to build a 3D model of an object and can be applied in many different fields. For example, animators can use a scan device to build the 3D model of an object to save the time spent for manual drawing. Another example, dental technicians can use a scan device to get the 3D model of a patient's tooth to produce a dental prosthesis. In the prior art, a scan device can build a 3D model by projecting a light beam with a fixed pattern to an object and reading the optical pattern reflected from the object. Because the surface of the object can have textures, the pattern reflected from the object would be different from the projected pattern. The scan device can build its 3D model according the characteristics of the object received from the difference of the patterns.

However, limited by the physical nature of device components, although a scan device can resolve effective depth information under specific depth of field, it can only get less accurate depth information outside that depth of field. The scan result then cannot be used in further application. In the prior art, corresponding physical components for the scan device need to be adapted to increase the effective depth of field. Therefore, it not only costs more for hardware but it is also less flexible in manufacturing process.

### SUMMARY OF THE INVENTION

The present invention provides a three-dimensional scan system comprising a projection module, an image capturing module and a beam splitting module. The projection module comprises a light source configured to provide a first light beam and a second light beam, and a pattern generator configured to receive the first light beam to project a first pattern, and to receive the second light beam to project a second pattern. The image capturing module is configured to capture an image of the first pattern and the second pattern projected on an object. The beam splitting module comprises a first reflective surface configured to reflect the first light beam to project the first pattern onto the object and reflect the first light beam reflected by the object to the image capturing module, and a second reflective surface parallel to the first reflective surface, configured to reflect the second light beam to project the second pattern onto the object and reflect the second light beam reflected by the object to the image capturing module.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a three-dimensional scan system according to an embodiment.

FIG. 2 is a diagram of modulation transfer function curves.

FIG. 3 is a diagram of a three-dimensional scan system according to another embodiment.

### DETAILED DESCRIPTION

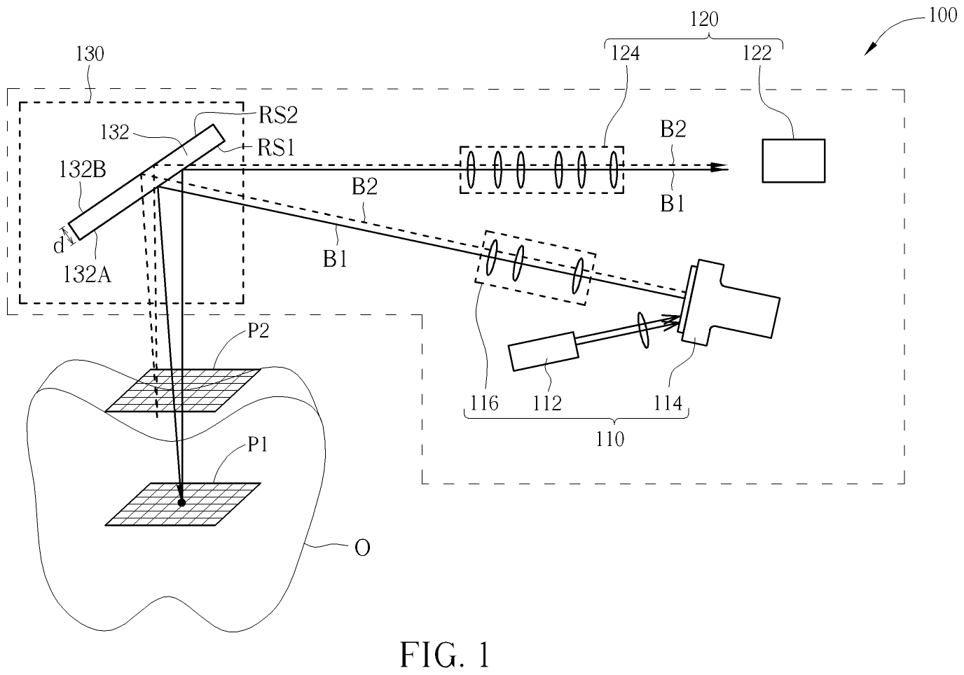

FIG. 1 is a diagram of a three-dimensional scan system 100 according to an embodiment of the present invention. The three-dimensional scan system 100 includes a projection module 110, an image capturing module 120, and a beam splitting module 130.

The projection module 110 includes a light source 112 and a pattern generator 114. The light source 112 can provide a first light beam B1 and a second light beam B2, wherein the first light beam B1 has a first wavelength and the second light beam B2 has a second wavelength different from the first wavelength. The pattern generator 114 may receive the first light beam B1 to project the first pattern P1 and receive the second light beam B2 to project the second pattern P2.

In some embodiments, the pattern generator 114 may include a digital micromirror device, a dynamic grating generator or a static grating generator to project the first pattern P1 and the second pattern P2. In some embodiments of the present invention, the first pattern P1 and the second pattern P2 may be, for example but not limited to, a checkered pattern, and the first pattern P1 and the second pattern P2 may have substantially the same pattern structure.

The beam splitting module 130 includes a first reflective surface RS1 and a second reflective surface RS2, and the second reflective surface RS2 is parallel to the first reflective surface RS1. The first reflective surface RS1 can reflect the first light beam B1 to project the first pattern P1 to the object O, and reflect the first light beam B1 reflected by the object O to the image capturing module 120. In the embodiment of FIG. 1, the projection module 110 may further include a set of lenses 116 that can guide the first light beam B1 to a suitable path to enter the first reflective surface RS1. In addition, the image capturing module 120 can include an image capturing unit 122 and a set of lenses 124. The image capturing unit 122 can capture the image, and the set of lenses 124 can transmit the first light beam B1 to the image capturing unit 122 through the required projection path to ensure that the image capturing unit 122 can receive the first light beam B1 reflected by the object O.

In this way, the image capturing module 120 can capture the image of the first pattern P1 projected on the object O. Since the surface of the object O have a certain figure, the first pattern P1 presented by the first light beam B1 reflected by the object O would change shape. The three-dimensional scan system 100 can compare original first pattern P1 with the changed first pattern P1 to obtain the features of the object O so as to establish a three-dimensional model.

In some embodiments, the first reflective surface RS1 reflects light beams having a first wavelength and allows light beams having a second wavelength to penetrate. It means that the first reflective surface RS1 can allow the second light beam B2 to penetrate. The second light beam B2 would penetrate the first reflective surface RS1 and be reflected by the second reflective surface RS2 and project the second pattern P2 onto the object O. The second light beam B2 reflected by the object O would then be received by the image capturing module 120. In this way, the image capturing module 120 can capture the image of the object O and the system can build the three-dimensional model accordingly.

In the embodiment of FIG. 1, the first reflective surface RS1 and the second reflective surface RS2 are parallel, and the distance between them is a fixed distance d. The length of the projection path of the first light beam B1 projected onto and reflected by the object O to the image capturing module 120 is different from the length of the projection path of the second light beam B2 projected onto and reflected by the object O to the image capturing module 120. When the first light beam B1 and the second light beam B2 reflected by the object O are applied to obtain the features of the object O, the depth of field that gives the optimal resolution would not be identical.

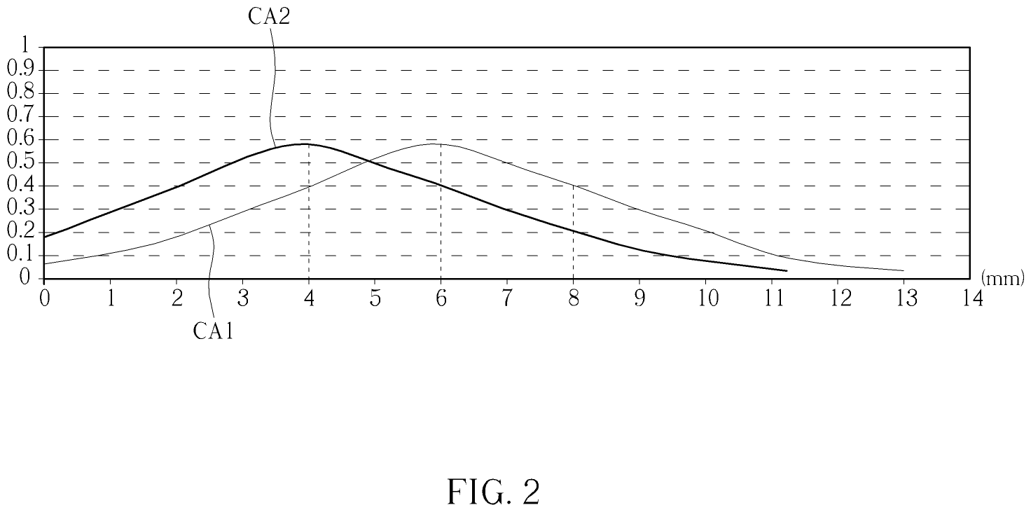

FIG. 2 is a diagram of a modulation transfer function (MTF) curve CA1 and a modulation transfer function curve CA2. The modulation transfer function curve CA1 corresponding to the three-dimensional scan system 100 scans with the first light beam B1 and the modulation transfer function curve CA2 corresponding to the three-dimensional scan system 100 scans with the second light beam B2. In FIG. 2, the horizontal axis is the depth of field, and the vertical axis is the resolution. In the embodiment of FIG. 1, since the second light beam B2 is reflected by the second reflective surface RS2 after penetrating the first reflective surface RS1, the second light beam B2 has a longer projection path resulting in the main projection imaging focal plane of the second projection P2 projected by the second light beam B2 being at a shallower position. In contrast, the first beam B1 has a shorter projection path, resulting in the main projection imaging focal plane of the first pattern P1 projected by the first beam B1 being at a deeper position. For example, in FIG. 2, the modulation transfer function curve CA1 has a peak at the depth of field of 6 mm, while the modulation transfer function curve CA2 has a peak at the depth of field of 4 mm.

In the prior art, if the subsequent image processing system can only process images with a resolution of 0.4 or higher, only the features with depth ranging from 4 mm to 8 mm can be obtained by scanning the object O with the first light beam B1. However, since the three-dimensional scan system 100 has the second light beam B2, it can obtain the features the object O with depth ranging 2 mm to 8 mm. It significantly improves the range of effective resolution.

In some embodiments, the light source 112 can provide the first light beam B1 and the second light beam B2 in different time periods, so that the image capturing module 120 can extract the reflected light beams of different wavelengths in different time periods. The features of the object O can be obtained separately. However, in some other embodiments, if the image capturing module 120 is capable of distinguishing light beams of different wavelengths in the same image, the light source 112 may simultaneously provide the first light beam B1 and the second light beam B2. In this case, the image capturing module 120 can separately provide the image of the first pattern P1 projected on the object O and the image of the second pattern P2 projected on the object O to the subsequent image processing system so that it can shorten the processing time.

In the embodiment of FIG. 1, the beam splitting module 130 can include a lens 132. The lens 132 has a first surface 132A and a second surface 132B. A thickness d is between the first surface 132A and the second surface 132B. In some embodiments, the first surface 132A may be coated with a first reflective film to form a first reflective surface RS1, and the second surface 132B may be coated with a second reflective film to form a second reflective surface RS2. The first reflective surface RS1 and the second reflective surface RS2 can be formed by coating a reflective film capable of reflecting a specific wavelength on both surfaces of the lens 132. In some embodiments, the lens 132 can be a planar lens.

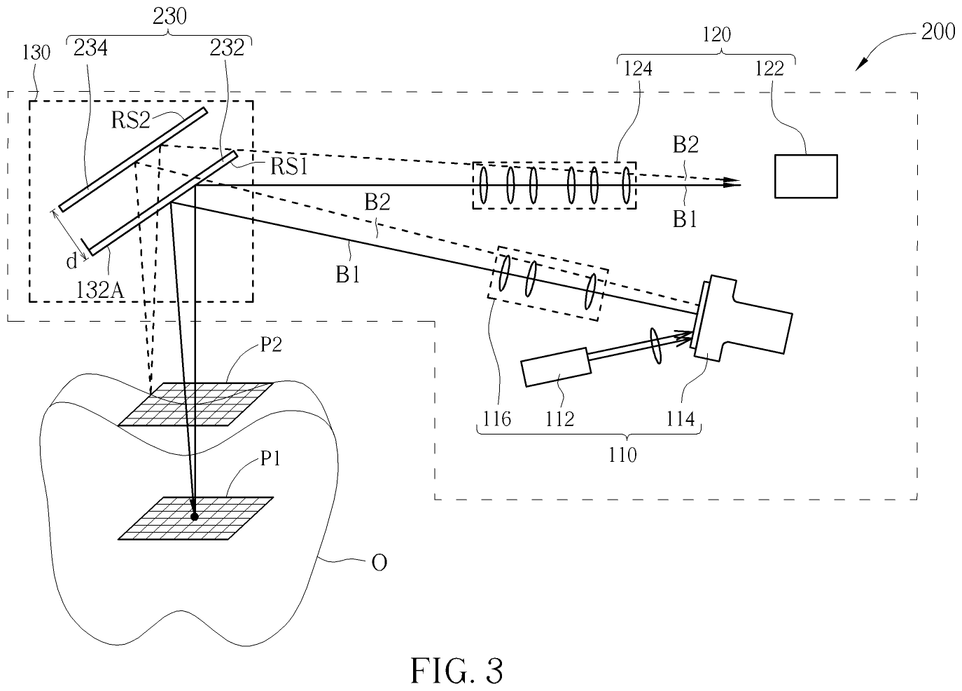

The present invention is not limited to coating on the same lens 132. FIG. 3 is a diagram of a three-dimensional scan system 200 according to another embodiment. The three-dimensional scan system 200 has a similar structure and operation principle to the three-dimensional scan system 100. However, the beam splitting module 230 of the three-dimensional scan system 200 includes a first lens 232 and a second lens 234. The first lens 232 and the second lens 234 are disposed in parallel. A surface of the first lens 232 is coated with a first reflective film to form a first reflective surface RS1, and a surface of the second lens 234 is coated with a second reflective film to form a second reflective surface RS2. In some embodiments, the first lens 232 and the second lens 234 can be planar lenses. In this case, by adjusting the distance d between the first lens 232 and the second lens 234, the range of depth of field can be adjusted to obtain the required resolution, so that it increases the flexibility in design and manufacturing.

In summary, the three-dimensional scan system provided by the embodiment of the present invention can project a pattern to an object by using the first light beam and the second light beam having different projection paths, thereby increasing the range of effective resolution. Since the three-dimensional scan system of the embodiment can reflect light beams of different wavelengths through the reflective film of the beam splitting module, it does not require special optical material and optical component with special curvature. This can increase the flexibility in design and manufacturing of the three-dimensional scan system.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A three-dimensional scan system comprising:
a projection module comprising:
a light source configured to provide a first light beam and a second light beam, wherein the first light beam has a first wavelength, and the second light beam has a second wavelength different from the first wavelength; and
a pattern generator configured to receive the first light beam to project a first pattern, and to receive the second light beam to project a second pattern;
an image capturing module configured to capture an image of the first pattern and the second pattern projected on an object; and
a beam splitting module comprising:
a first reflective surface configured to reflect the first light beam to project the first pattern onto the object and reflect the first light beam reflected by the object to the image capturing module; and
a second reflective surface parallel to the first reflective surface, configured to reflect the second light beam to project the second pattern onto the object and reflect the second light beam reflected by the object to the image capturing module.

2. The three-dimensional scan system of claim 1, wherein the light source provides the first light beam and the second light beam in different time periods.

3. The three-dimensional scan system of claim 1, wherein the light source simultaneously provides the first light beam and the second light beam.

4. The three-dimensional scan system of claim 1, wherein the first pattern and the second pattern have substantially a same pattern structure.

5. The three-dimensional scan system of claim 1, wherein the beam splitting module further comprises:
a lens having a first surface and a second surface, wherein a thickness is between the first surface and the second surface; wherein:
the first surface is coated with a first reflective film to form the first reflective surface; and
the second surface is coated with a second reflective film to form the second reflective surface.

6. The three-dimensional scan system of claim 1, wherein the beam splitting module further comprises:
a first lens coated with a first reflective film to form the first reflective surface; and
a second lens coated with a second reflective film to form the second reflective surface;
wherein the first lens and the second lens are disposed in parallel and at a distance.

7. The three-dimensional scan system of claim 1, wherein the first reflective surface allows the second light beam having the second wavelength to penetrate.
